(19) United States
(12) Patent Application Publication
(10) Pub. No.: US 2026/0097687 A1
(43) Pub. Date: Apr. 9, 2026

(54) METHOD FOR CONTROLLING DUAL BATTERIES AND VEHICLE USING THE SAME

(71) Applicants: HYUNDAI MOTOR COMPANY, Seoul (KR); KIA CORPORATION, Seoul (KR)

(72) Inventor: Won Jae Lee, Hwaseong-si (KR)

(73) Assignees: HYUNDAI MOTOR COMPANY, Seoul (KR); KIA CORPORATION, Seoul (KR)

(21) Appl. No.: 19/258,477

(22) Filed: Jul. 2, 2025

(30) Foreign Application Priority Data
Oct. 8, 2024 (KR) 10-2024-0136904

(51) Int. Cl. B60L 58/20; B60L 58/12; B60L 58/22; B60L 58/26

(52) U.S. Cl. CPC B60L 58/20; B60L 58/12; B60L 58/22; B60L 58/26; B60L 2210/12; B60L 2210/14; B60L 2240/545; B60L 2260/42; B60L 2260/44; B60L 2260/46; B60L 2260/54

(57) ABSTRACT

A method for controlling dual batteries to supply power to a driving motor for wheel driving installed in a vehicle is provided. The method includes controlling a power flow between a first battery and a second battery. The method further includes determining a usage plan of the first battery and the second battery for each section of an expected driving path, correcting the usage plan of a corresponding section when a battery used in two consecutive sections is changed based on the usage plan, and charging or discharging the first battery and the second battery based on the corrected usage plan.

### CROSS-REFERENCE TO RELATED APPLICATION(S)

The present application claims priority to Korean Patent Application No. 10-2024-0136904, filed on Oct. 8, 2024, the entire contents of which are incorporated herein for all purposes by this reference.

### TECHNICAL FIELD

The present disclosure relates to a method for controlling dual batteries and a vehicle using the same.

### BACKGROUND

In general, an electric vehicle is a kind of mobility device that runs as wheels thereof are driven by a driving force of a driving motor.

Also, in general, a high-voltage battery may be (e.g., fixedly) mounted onto a vehicle to supply power to the driving motor.

The driving motor may be an AC motor, and accordingly, an inverter may be provided between the battery and the driving motor.

The battery of the electric vehicle is charged by receiving external power through an on board charger (OBC) when charging is needed (e.g., required) according to a charge state thereof, e.g., state of charge (SoC).

A charging time may be determined according to a charging method and divided into slow charging and fast charging.

In recent years, continuing research and development on batteries have improved a driving range per charge.

However, the battery mounted on the electric vehicle may still be insufficient, and therefore, an alternative may be useful.

### SUMMARY

The present disclosure provides a second high-voltage battery that may be added to and detached from a power system of an electric vehicle as desired (or as necessary) in addition to a first high-voltage battery installed (e.g., in advance) in the electric vehicle.

The present disclosure also provides a method for determining a usage plan of dual batteries for each section of an expected driving path to obtain an efficient operation of the dual batteries.

The present disclosure also provides a method for reducing a loss in power circuit and improving a battery conditioning efficiency by executing a battery operation corrected based on a usage plan when replacing dual batteries according to the usage plan.

An example embodiment of the present disclosure provides a method for controlling usage of dual batteries including a first battery and a second battery to supply power to a driving motor for wheel driving installed in a vehicle. The method includes determining a usage plan of the first battery or the second battery for each section of an expected driving path, changing the usage plans for two consecutive sections when a battery for a previous section of the two consecutive sections is different from a battery for a next section of the two consecutive sections, and charging or discharging the first battery or the second battery based on the changed usage plans.

In an example embodiment, the changing the usage plans comprises changing the usage plans based on an energy efficiency condition for the next section of the two consecutive sections.

In an example embodiment, the energy efficiency condition is based on a first consumed energy estimated by using the battery for the previous section in the next section and a second consumed energy estimated by using the battery for the next section in the next section.

In an example embodiment, the first consumed energy comprises consumed energy of the battery for the previous section to drive the vehicle in the next section.

In an example embodiment, the second consumed energy comprises consumed energy of the battery for the next section to drive the vehicle in the next section, conditioning energy of the battery for the next section to prepare to drive the vehicle in the next section, and coolant energy for the conditioning energy.

In an example embodiment, the changing the usage plans comprises comparing consumed energy of the battery for the previous section to drive the vehicle in the next section with combined energy of consumed energy of the battery for the next section to drive the vehicle in the next section, conditioning energy of the battery for the next section to prepare to drive the vehicle in the next section, and coolant energy for the conditioning energy.

In an example embodiment, the changing the usage plans further comprises determining whether the battery for the next section is identical to (e.g., the same as) a battery for a subsequent section of the next section when the consumed energy of the battery for the previous section to drive the vehicle in the next section is less than the combined energy.

In an example embodiment, the changing the usage plans further comprises comparing the consumed energy of the battery for the previous section to drive the vehicle in the next section with the consumed energy of the battery for the next section to drive the vehicle in the next section when the battery for the next section is identical to (e.g., the same as) the battery for the subsequent section of the next section.

In an example embodiment, the changing the usage plans may include: maintaining the usage plan of the next section when the consumed energy of the battery for the previous section to drive the vehicle in the next section is greater than the consumed energy of the battery for the next section to drive the vehicle in the next section; and changing the usage plan of the next section otherwise.

In an example embodiment, the changing the usage plan may further include maintaining the usage plan of the next section when the consumed energy of the battery for the previous section to drive the vehicle in the next section is greater than or equal to the combined energy, and changing the usage plan of the next section when the battery for the next section is different from the battery for the subsequent section of the next section.

In an example embodiment of the present disclosure, a vehicle includes a plurality of wheels, a driving motor configured to drive at least one of the plurality of wheels, and a controller configured to control a power flow between the driving motor and first and second batteries. The controller includes a memory configured to store a computer program and at least one processor. The at least one processor is configured to execute the computer program and performs, through execution of the computer program, determining a usage plan of the first battery and the second battery for each section of an expected driving path, correcting the usage plan in a corresponding section when a battery used in two consecutive sections is changed based on the usage plan, and charging or discharging the first battery and the second battery based on the corrected usage plan.

In an example embodiment, the correcting of the usage plan may include correcting the usage plan based on an energy efficiency condition for a next section among the two consecutive sections.

In an example embodiment, the energy efficiency condition may be based on first consumed energy when a battery to be used in a previous section among the two sections is used in the next section and second consumed energy when a battery to be used in the next section is used in the next section.

In an example embodiment, the first consumed energy may include consumed energy of the battery to be used in the previous section due to next section driving.

In an example embodiment, the second consumed energy may include consumed energy of the battery to be used in the next section due to the next section driving, conditioning energy of the battery to be used in the next section to prepare the next section driving, and coolant energy for the conditioning energy.

In an example embodiment, the correcting of the usage plan may include comparing consumed energy of the battery to be used in the previous section due to next section driving with combined energy of the consumed energy of the battery to be used in the next section due to next section driving, the conditioning energy of the battery to be used in the next section to prepare the next section driving, and the coolant energy for the conditioning energy.

In an example embodiment, the correcting of the usage plan may further include determining whether the battery to be used in the next section is the same as a battery to be used in a subsequent section of the next section when the consumed energy of the battery to be used in the previous section due to next section driving is less than the combined energy.

In an example embodiment, the correcting of the usage plan may further include comparing the consumed energy of the battery to be used in the previous section due to the next section driving with the consumed energy of the battery to be used in the next section due to the next section driving when the battery to be used in the next section is the same as the battery to be used in a subsequent section of the next section.

In an example embodiment, the correcting of the usage plan may further include maintaining the usage plan of the next section when the consumed energy of the battery to be used in the previous section due to the next section driving is greater than the consumed energy of the battery to be used in the next section due to the next section driving, and changing the usage plan of the next section otherwise.

In an example embodiment, the correcting of the usage plan may further include maintaining the usage plan of the next section when the consumed energy of the battery to be used in the previous section due to the next section driving is not less than the combined energy, and correcting the usage plan of the next section when the battery to be used in the next section is not same as the battery to be used in the subsequent section of the next section.

### BRIEF DESCRIPTION OF THE DRAWINGS

FIG. 1 is a view illustrating a power system of a first mobility according to an example embodiment of the present disclosure.

FIG. 2 is a view illustrating a state in which the first mobility is connected to a second mobility according to an example embodiment of the present disclosure.

FIG. 3 is a flowchart illustrating a process of controlling dual batteries according to an example embodiment of the present disclosure.

FIG. 4 is a flowchart illustrating a process of checking and adjusting a battery usage plan according to an example embodiment of the present disclosure.

FIG. 5 is a table illustrating an example of driving habit data for each driving condition.

FIGS. 6A and 6B are graphs illustrating a driving simulation according to an example embodiment of the present disclosure.

FIG. 7 is a graph illustrating another driving simulation according to an example embodiment of the present disclosure.

FIG. 8 is a graph illustrating an example of a battery usage plan for each section and a final determination in FIG. 7.

### DETAILED DESCRIPTION

Since the present disclosure may have diverse modified embodiments, example embodiments are illustrated in the drawings and are described in the detailed description of the disclosure. However, this does not limit the present disclosure within the example embodiments and it should be understood that the present disclosure covers the modifications, equivalents, and replacements within the idea and technical scope of the present disclosure.

In this specification, the suffixes “module” and “unit” are used for nominal distinction between components and should not be interpreted as implying that the components are physically or chemically separated or that they may be separated.

Although the terms of “first” and “second” are used herein to describe various elements, these elements should not be limited by these terms. These terms may be used to differentiate one component from another in name, and their sequential meanings are understood through the context of the description rather than by the names themselves.

The term “and/or” is used to include possible combinations of the listed items. For example, “A and/or B” includes three cases of “A”, “B”, and “A and B”.

When an element is referred to as being “‘connected to” or “engaged with” another element, it may be directly connected to the other element, or intervening elements may also be present.

In the following description, the technical terms may be used for explaining a specific exemplary embodiment while not limiting the present disclosure. The terms of a singular form may include plural forms unless referred to the contrary. The meaning of ‘include’ or ‘comprise’ specifies a property, a region, a set (e.g., fixed) number, a step, a process, an element and/or a component but does not exclude other properties, regions, set (e.g., fixed) numbers, steps, processes, elements and/or components.

Unless terms used in the present disclosure are provided differently, the terms may be construed as understood by those skilled in the art. Terms such as terms that are generally in dictionaries should be construed as having meanings matched with contextual meanings in the art. In this description, unless provided, terms should not be construed to have ideally, excessively construed as formal meanings.

Also, the terms unit, control unit, control device, or controller are used to name devices that control specific functions and do not refer to a generic functional unit. Also, the devices denoted by the names may include a communication device that communicates with another controller or sensor to control the corresponding function, a computer-readable recording medium that stores an operation system, a logic command, and input/output information, and at least one processor that performs determinations, decisions, and calculations required for function control.

The processor may include semiconductor integrated circuits and/or electronic elements that perform at least one or more of comparisons, determinations, calculations, and/or decisions to achieve programmed functions. For example, the processor may be a computer, a microprocessor, CPU, ASIC, an electronic circuitry (logic circuits), or a combination thereof.

Also, the computer readable recording medium (or memory) includes various data storage devices that store computer readable data. For example, the computer readable recording medium may include at least one of a flash memory type, hard disk type, micro type, card type (e.g., secure digital (SD) card) or eXtream digital (XD) type memory and a random access memory (RAM), static RAM (SRAM), read-only memory (ROM), programmable ROM (PROM), electrically erasable PROM (EEPROM), magnetic RAM (MRAM), magnetic disk, or optical disk type memory.

The recording media may be electrically connected to the processor, and the processor may read data from and write data to the recording media. The recording media and the processor may be integrated with each other or physically separated from each other.

Hereinafter, the accompanying drawings provide at least one embodiment of the present disclosure and will be described in detail with reference to the drawings.

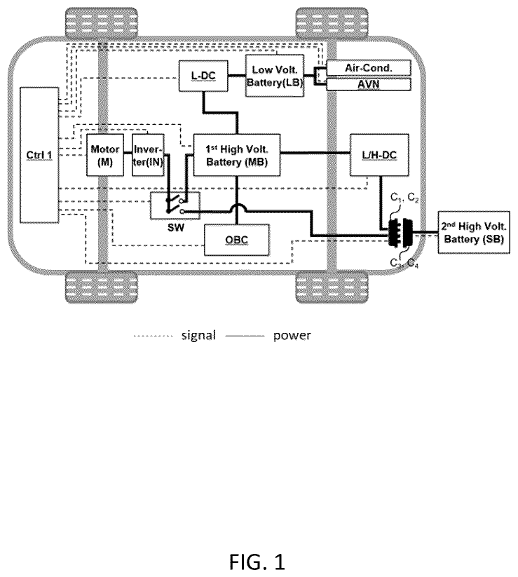

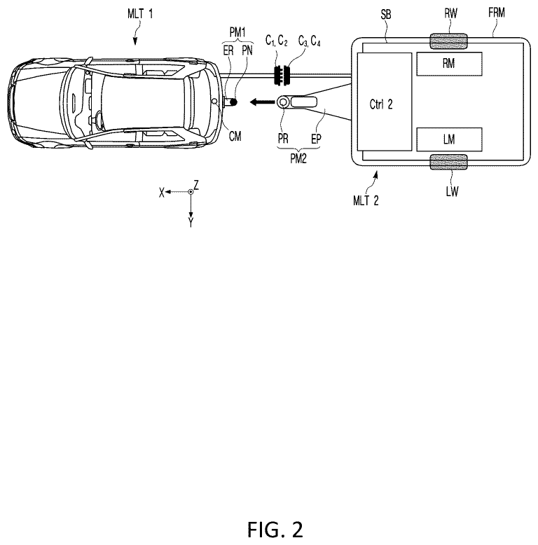

FIG. 1 is a conceptual view illustrating a power system of a first mobility MLT 1 (e.g., an electric vehicle) according to an example embodiment of the present disclosure, and FIG. 2 is a view illustrating a state in which a second mobility MLT 2 is connected to the first mobility MLT 1.

A structure of each of the first mobility MLT1 and the second mobility MLT 2 according to an example embodiment of the present disclosure will be described with reference to FIGS. 1 and 2.

As illustrated in FIG. 1, the first mobility MLT1, which may be an electric vehicle, according to an example embodiment of the present disclosure includes a first driving motor M, an inverter IN, a first battery MB, an on-board charger OBC, a first DC/DC converter L-DC, a low-voltage battery LB, an air-conditioner Air-cond and an audio video navigation AVN, which operate with a low-voltage, a second DC/DC converter L/H-DC, a switch SW, and a controller (hereinafter, referred to as a first controller).

The first driving motor M provides a driving force to wheels of the vehicle. For example, the first driving motor M may be an alternating current motor.

The inverter IN converts direct current power supplied to the first driving motor M into alternating current.

The first battery MB may be (e.g., fixedly) installed in a body of the first mobility MLT 1, such as under a cabin floor.

The first battery MB may have a main function of supplying electric power to the first driving motor M and may be charged by the on-board charger OBC.

Also, the first battery MB may be connected to the low-voltage battery LB through the first DC/DC converter L-DC to charge the low-voltage battery LB.

The first DC/DC converter L-DC may be a low-voltage DC-DC converter LDC in order to charge the low-voltage battery LB.

The low-voltage battery LB may be, for example, a 12 V or 24 V battery. The low-voltage battery LB supplies electric power to an electrical device in the vehicle, such as the air conditioner and AVN that operate at a low voltage.

A second battery SB illustrated in FIG. 1 is installed in the second mobility MLT 2 and mechanically connected through a coupling mechanism, described herein. However, the example embodiment of the present disclosure is not limited thereto. For example, the second battery SB may be mechanically connected by being detachably installed on or to the first mobility.

The second battery SB may be electrically connected additionally to a vehicle power system including the first battery MB (e.g., in a separably wired method (or a wireless method within an allowable range)) that has no effect on an operation (e.g., power supply to electronic components of the vehicle and the driving motor) of the power system.

Also, although the second battery SB may be referred to as a replaceable battery, auxiliary battery, extended battery, second or secondary battery, this is for differentiating the second battery SB from the first battery MB. Features of the second battery SB, such as a function, characteristics, a mechanical/electrical/chemical structure according to a relationship with other objects (e.g., including the first battery MB and a host vehicle), a battery type (e.g., including the kinds of packaging method, positive electrode material/negative electrode material/separation membrane material), and a charging method, are not limited by a name of the second high-voltage battery SB.

The second battery SB may be connected to a first controller Ctrl 1 of the first mobility MLT1 or a battery management system (BMS) of the first battery MB, described herein, in a wired or wireless manner. Through this, sensing information (e.g. voltage, current, temperature, etc.) related to a SoC state and a physical/electrical/chemical state of the second battery SB is transmitted to the first controller Ctrl 1. However, the example embodiment of the present disclosure is not limited thereto. For example, the above-described information related to the second battery SB may be transmitted to the first controller Ctrl 1 through a second controller Ctrl 2 of the second mobility MLT 2, described herein.

In this example embodiment, a high-voltage battery applied to the first battery MB and the second battery SB may include a plurality of battery cells (not shown) that output a voltage of (e.g., 2.7 V to 4.2 V), and the number of the plurality of battery cells to be connected in series or parallel may be set, so that the plurality of battery cells form a (e.g., one) module. The high-voltage battery may be packaged such that one or more battery modules are connected in series or parallel as a (e.g., one) battery to output (e.g., about 400 V, about 800 V, or several kV).

Each of the first battery MB and the second battery SB may include a battery management system (BMS).

The BMS may include a battery management unit (BMU), a cell monitoring unit (CMU), and a battery junction box (BJB).

The BMS performs a cell balancing function of maintaining a voltage of each of cells constant to secure a performance of an entire battery pack, a state of charge (SoC) function of calculating a capacity of an entire battery system, battery cooling, charging, and discharging control.

The BMU receives information on (e.g., all) cells from the CMU and performs the functions of the BMS based on the received information.

The BMU may include (e.g., two) micro control units (MCU), and each MCU may have a (e.g., one) CAN communication port. The BMU may further include a CAN interface to communicate with a vehicle controller that is a device at an upper hierarchy level of the BMS and a CAN interface to collect information from the CMU that is a device at a lower hierarchy level of the BMS.

The CMU may be attached (e.g., directly) to the battery cell to sense a voltage, a current, and a temperature. The CMU may serve to perform sensing (e.g., only) instead of performing a calculation related to a BMS algorithm. A (e.g., one) CMU may be formed by connecting a plurality of battery cells and transmit information of each cell to the BMU through the CAN interface.

BJB is a pack-level sensing mechanism of the BMS and a connection medium between the high-voltage battery and a drivetrain. For (e.g., accurately) calculating the SoC, a battery voltage and a current flowing into and out of the battery are measured and recorded. Also, the BJB may perform a safety function, such as insulation monitoring in addition to overcurrent detection.

The second battery SB may be a high-voltage battery having a voltage less than that of the first battery MB, and in this case, the second DC/DC converter L/H-DC may be a step-up DC/DC converter. Alternatively, the second battery SB may be a high-voltage battery having a voltage greater than that of the first battery MB, and in this case, the second DC/DC converter L/H-DC may be a step-down DC/DC converter. Also, in this alternative example embodiment, the second DC/DC converter L/H-DC may be a bidirectional converter, and thus, the first battery MB and the second battery SB may charge and discharge each other.

In this example embodiment, although the second DC/DC converter L/H-DC is included as a built-in component of the first mobility MLT1 in the power system, the example embodiment of the present disclosure is not limited thereto. For example, unlike this example embodiment, the second DC/DC converter L/H-DC may be provided as a separate component and additionally and detachably connected to the power system. Also, the second DC/DC converter L/H-DC may be built-in or detachably included in the second mobility MLT 2.

Also, unlike the present embodiment, the second DC/DC converter L/H-DC may not be included in other embodiments. In this case, charging and discharging between the first battery MB and the second battery SB may not occur.

In this example embodiment, the power system of the first mobility MLT1 may include first and second connectors C1 and C2, and the second battery SB may include third and fourth connectors C3 and C4 for a separable electrical connection to the power system of the second battery SB.

For example, each of the first and second connectors C1 and C2 may be an integrated connector, and each of the third and fourth connectors C3 and C4 may be also an integrated connector.

The first connector C1 may be connected to the second DC/DC converter L/H-DC, and the second connector C2 may be connected to the switch SW.

Although not shown, a signal transmission connector may be added to transmit sensing and state information of the second battery SB to the controller.

The switch SW is (e.g., fixedly) electrically connected to the inverter IN and switched between the first battery MB and the second connector C2 to electrically connect the inverter IN and the first battery MB and/or the inverter IN and the second battery SB.

In this example embodiment, although the first controller Ctrl 1 may be a vehicle controller at an uppermost hierarchy level, which controls (e.g., all) electric devices of the first mobility MLT1, the example embodiment of the present disclosure is not limited thereto. For example, the first controller Ctrl 1 in FIG. 1 may be a power controller at a lower hierarchy level of the vehicle controller.

Also, in this example embodiment, as described above, the first controller Ctrl 1 may include a computer-readable recording medium that stores an operation system, a logic command, and input/output information and at least one processor that reads the above-described stored system, command, and information to perform a decision or calculation required for function control.

The second battery SB in FIG. 1 may be installed in the second mobility MLT 2 as illustrated in FIG. 2.

The second mobility MLT 2 includes a frame FRM, a second left wheel LW disposed at a left side of the frame FRM, a second right wheel RW disposed at a right side of the frame FRM, a second left driving motor LM providing driving force to the second left wheel LW, a second right driving motor RM providing driving force to the second right wheel RW, and a second controller Ctrl 2.

Although the second battery SB may be (e.g., fixedly) installed on the second mobility MLT 2, the example embodiment of the present disclosure is not limited thereto. That is, the second battery SB may be detachably installed on the second mobility MLT 2. For example, the second battery SB in a completely discharged SoC state, which is mounted to the frame FRM, may be removed and replaced with a new second battery SB in a fully charged SoC state.

When the second battery SB is (e.g., fixedly) installed on the second mobility MLT 2, the second mobility MLT 2 may include a charging connector for charging the second battery SB.

The frame FRM forms an appearance of the second mobility MLT 2 and may serve to accommodate other components.

The frame FRM may include a second pivot mechanism PM2 that is a second connection mechanism, and the second pivot mechanism PM2 may be separably pivot-connected to a first pivot mechanism PM1 that is a first connection mechanism coupled (e.g., fixed) to a body of the first mobility MLT1.

For example, the first pivot mechanism PM1 includes an extension rod ER extending rearward from the body of the first mobility MLT1 and a pivot pin PN protruding upward from an end of the extension rod ER.

Also, the second pivot mechanism PM2 includes an extension part EP having a triangular shape protruding forward from the frame FRM of the second mobility MLT 2 and a pivot ring PR disposed at an end of the extension part EP and to which the pivot pin PN is rotatably inserted.

The pivot pin PN may perform a restricted linear movement in a state of being inserted to the pivot ring PR and may (e.g., only) perform a rotation in a Z-axis direction of FIG. 2. Thus, in the pivot-connected state, the second mobility MLT2 may be restricted in linear movement using a pivot connection point as a center with respect to the first mobility MLT1 and may (e.g., only) rotate about a Z axis.

When the second mobility MLT2 travels in a forward direction (e.g., an X-axis direction), each of the first mobility MLT1 and the second mobility MLT2 may maintain straightness thereof without separate steering control.

Although the pivot mechanism is included as the first and second connection mechanisms in this example embodiment, the example embodiment of the present disclosure is not limited thereto. For example, the first and second connection mechanisms may be mechanisms that realize non-rotational connection about the Z-axis.

The second left driving motor LM has a rotation shaft that is connected to the second left wheel LW, and through this, the second left driving motor LM provides driving force to the second left wheel LW.

Also, the second right driving motor RM has a rotation shaft that is connected to the second right wheel RW, and through this, the second right driving motor RM provides driving force to the second right wheel RW.

Since the second left wheel LW and the second right wheel RW are connected to the second left driving motor LM and the second right driving motor RM, respectively, the second left wheel LW and the second right wheel RW may be driven independently from each other.

Since each of the second left driving motor LM and the second right driving motor RM may be driven in forward and backward directions, when driven in the forward direction, the second mobility MLT 2 travels forward, and when driven in the backward direction, the second mobility MLT 2 travels backward.

For example, although each of the second left driving motor LM and the second right driving motor RM may be realized as an in-wheel driving system in which each driving motor is installed in each wheel, the example embodiment of the present disclosure is not limited thereto.

Also, in comparison (e.g., unlike this example embodiment), the second mobility MLT 2 may be driven in such a manner that power of one common motor is distributed to the second left wheel LW and the second right wheel RW instead of independent driving of the left and right wheels. To this end, a differential gear may be included between the common second driving motor and the second left and right wheels LW and RW. That is, the power of the common second driving motor may be distributed by the differential gear and transmitted to the second left wheel LW and the second right wheel RW. In this case, a torque vectoring unit may be added for torque distribution between the second left wheel LW and the second right wheel RW.

In FIG. 2, the second controller Ctrl 2 controls the second left driving motor LM and the second right driving motor RM to perform forward and reverse driving of the second mobility MLT 2. Also, when steering of the second mobility MLT 2 is desired (e.g., required), the second controller Ctrl 2 may change a driving direction of the second mobility MLT2 through controlling a torque or the number of rotations of each of the second left driving motor LM and the second right driving motor RM. That is, the steering of the second mobility MLT 2 may be performed without a separate steering device through independent control of the driving of the second left driving motor LM and the second right driving motor RM.

Also, as described above, the connectors and the wired or wireless communication units for transmitting information between the first mobility MLT1 and the second mobility MLT2 in FIG. 1 are included.

In this example embodiment, each of the first controller Ctrl 1 and/or the second controller Ctrl 2 may include a memory and a processor. The memory stores computer commands (e.g., programs) for performing functions of the corresponding controller, and the processor performs the above-described functions by reading and executing the commands from the memory.

For example, the memory includes at least one of a hard disk drive (HDD), a solid-state drive (SDD), a silicon disk drive (SDD), ROM, RAM, CD-ROM, a magnetic tape, a floppy disk, and an optical data storage device.

Also, for example, the processor includes at least one of a computer, a microprocessor, a central processing unit (CPU), an ASIC, an electric circuit, and a logic circuit.

As the first connector C1 and the second connector C2 of the first mobility MLT 1 and the third connector C3 and the fourth connector C4 of the second mobility MLT 2 are connected, and the connector for signal transmission is connected, the first mobility MLT 1 and the second mobility MLT 2 (e.g., the first controller Ctrl 1 and the second controller Ctrl 2) may communicate with each other.

When the first mobility MLT 1 initiates travel forward in a state in which the first mobility MLT 1 and the second mobility MLT 2 are mechanically and electrically connected, according to a driving speed signal transmitted from the first connector C1, the second controller Ctrl 2 controls the second left driving motor LM and the second right driving motor RM to perform a forward straight driving of the second mobility MLT 2.

Here, a speed, a gear position, a steering angle, accelerator pedal sensor (APS) information, and/or brake pedal sensor (BPS) information of the first mobility MLT 1 may be transmitted to the second mobility MLT 2.

The second controller Ctrl 2 of the second mobility MLT 2 may determine whether the first mobility MLT 1 is in a forward driving state or a backward driving state by using, for example, some or all of the speed, the gear position, the APS information, and the BPS information of the first mobility MLT 1. However, the example embodiment of the present disclosure is not limited thereto. For example, the second controller Ctrl 2 may (e.g., directly) receive information on whether the first mobility MLT 1 is in the forward driving state or the backward driving state from the first controller Ctrl 1.

When the first mobility MLT1 travels forward, the second controller Ctrl 2 drives the second left driving motor LM and the second right driving motor RM in the forward direction to perform the forward driving of the second mobility MLT 2. When the first mobility MLT1 travels backward, the second controller Ctrl 2 drives the second left driving motor LM and the second right driving motor RM in the backward direction to perform the backward driving of the second mobility MLT 2.

Also, the second controller Ctrl 2 may determine a steering state through steering angle information of the first mobility MLT 1 and perform steering of the second mobility MLT 2 based on the determined steering state.

The second mobility MLT 2 may not include a separate steering device such as a steering wheel and a steering rack and may perform the steering through torque control of the second left driving motor LM and the second right driving motor RM.

That is, the second controller Ctrl 2 may calculate driving torque for driving and steering torque for steering for each of the second left driving motor LM and the second right driving motor RM and use the calculated torque for control.

For example, a lookup table or calculation program may include steering torque values of the second left driving motor LM and the second right driving motor RM according to the steering angle of the first mobility MLT 1 to perform steering of the second mobility MLT 2.

During the forward straight driving, the second mobility MLT 2 may be controlled to travel at a speed equal to or less than that of the first mobility MLT 1. Through this, the pivot connection between the first mobility MLT 1 and the second mobility MLT 2 may be maintained within a predetermined pivot angle range. For example, when a speed of the second mobility MLT 2 is controlled to be equal to or less than that of the first mobility MLT 1 during the forward straight driving, a pivot angle of the second mobility MLT2 with respect to the first mobility MLT 1 at a pivot connection point may maintain 0° (which represents an angle at which the first mobility MLT 1 and the second mobility MLT 2 are on a straight line).

During the forward straight driving, the second mobility MLT 2 may be controlled to follow the first mobility MLT 1, and through this, a plurality of mobilities may be (e.g., smoothly) connected to travel.

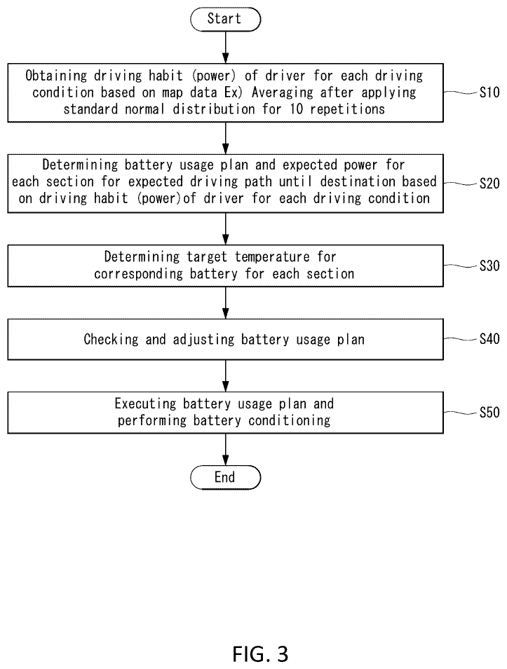

FIG. 3 is a flowchart illustrating a battery control process according to an example embodiment of the present disclosure, which will be described in detail below.

Although a control process of the battery is performed under control of the first controller Ctrl 1 in this example embodiment, the example embodiment of the present disclosure is not limited thereto.

The first controller Ctrl 1 includes a memory and a processor as described herein. The memory stores a computer program for a battery controls process according to the example embodiment and, as useful (e.g., necessary), may store various data (e.g., required) for the control process. The processor executes the program stored in the memory, and through this, the first controller Ctrl 1 may perform the battery control process.

Referring to FIG. 3, in step S10, the first controller Ctrl 1 collects (e.g., acquires) a driver's driving habit for each driving condition based on map data.

The map data may be, for example, the map data for navigation of the AVN system, but is not necessarily limited to this.

The driving condition may for example, be based on a road type indicated by the map data.

For example, the driving condition may be distinguished, based on the map data, into a plurality of sections, such as an urban road section, a mountainous up-hill section, a mountainous down-hill section, a highway section, a national road section, and a regenerative braking section.

The urban road section may include a road section provided as the urban road in the map data, the mountainous section may include a road section provided as the mountainous road in the map data, and the highway section and the national road section may include a road section provided as a highway and a road section provided as a national road, respectively, in the map data.

Also, regenerative braking may be performed based on a predetermined regenerative braking condition during driving, and the corresponding section may be provided as the regenerative braking section.

For example, the regenerative braking condition may include a deceleration rate, a driving distance or time to a target speed, and a state of charge (SoC) of the battery. However, the example embodiment of the present disclosure is not limited thereto.

The data on the driver's driving habit for each driving condition may be acquired, for example, through learning.

To this end, the power supplied to the driving motor M based on a (e.g., required) output of the driver during the driving of the vehicle over a preset driving distance for each driving condition (e.g., discharging power data of the battery MB or SB) is obtained in real time to determine the average discharging power during the driving distance and obtain average discharging power data by repeating this process a set number of times.

Also, an average value based on probability weighted value may be determined by applying a standard normal distribution to the obtained average discharging power data to determine average discharging power for the corresponding driving condition.

Here, for example, the required output of the driver may be determined based on a signal of an accelerator position sensor (APS).

Also, the regenerative braking power based on a deceleration demand of the driver during the predetermined driving distance for each driving condition (e.g., regenerative braking charging power data in the battery) may be collected in real-time to determine the average charging power during the driving distance and repeating this process a set number of times, thereby obtaining the average charging power data.

Also, in the same manner, an average value based on the probability weighted value may be determined by applying the standard normal distribution to the obtained average charging power data, and the determined average value may be determined as the average charging power for the corresponding driving condition.

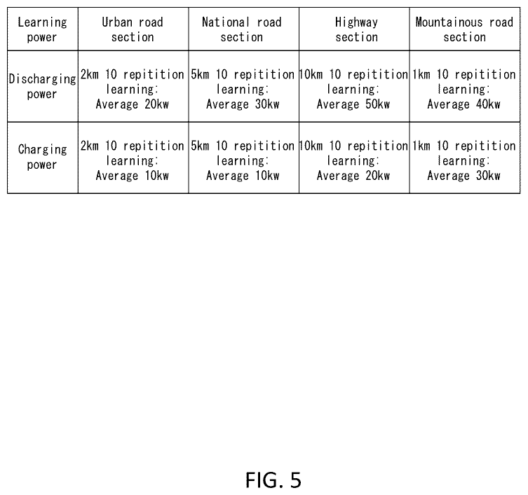

FIG. 5 is a table showing an example of obtaining average power through learning for each driving condition, described herein.

First, in an example embodiment, average discharging power by applying the standard normal distribution to discharging power obtained while driving 2 km on the urban road section for 10 repetitions is 20 kw.

Also, in an example embodiment, the average charging power by applying the standard normal distribution to discharging power obtained while driving 2 km on the urban road section for 10 repetitions is 10 kw.

In an example embodiment, average discharging power by applying the standard normal distribution to discharging power obtained while driving 5 km on the national road section for 10 repetitions is 30 kw, and average charging power by applying the standard normal distribution to charging power obtained while driving 5 km on the national road section for 10 repetitions is 10 kw.

In an example embodiment, average discharging power by applying the standard normal distribution to discharging power obtained while driving 5 km on the highway section for 10 repetitions is 50 kw, and the average discharging power by applying the standard normal distribution to charging power obtained while driving 5 km on the highway section for 10 repetitions is 20 kw.

Also, in an example embodiment, average discharging power by applying the standard normal distribution to discharging power obtained while driving 1 km on the mountainous road section for 10 repetitions is 40 kw, and the average discharging power by applying the standard normal distribution to charging power obtained while driving 1 km on the mountainous road section for 10 repetitions is 30 kw.

The driving habit data for each driving condition may be (e.g., continuously) updated by accumulating data for each condition.

Referring back to FIG. 3, in step S20, the first controller Ctrl 1 may determine at least one section based on the driving habit data for each driving condition for the expected driving path and determine expected power and a battery usage plan for each section.

For example, the expected driving path may be determined based on a path from a current location to a destination when the destination is input into the AVN.

For example, at least one section may be determined as the expected driving path based on driving conditions based on the urban road section, the mountainous road section, the highway section, the national road section, and the regenerative braking section.

The first controller Ctrl 1 may determine expected power (e.g., charging or discharging power) for each section based on the driving habit data for each driving condition.

Also, the first controller Ctrl 1 may determine the battery to be used such as the first battery MB and/or the second battery SB for each section.

The battery to be used in each section may be determined based on the expected power for the corresponding section and output power of a maximum efficiency of a lower voltage battery among the first battery MB and the second battery SB.

Hereinafter, an example in which the first battery MB is the lower voltage battery than the second battery SB will be described. However, this is an example and the example embodiment of the present disclosure is not limited thereto. Hereinafter, for convenience and clarity in the description, the first battery MB will be referred to as a ‘low-voltage battery,’ and the second battery SB will be referred to as a ‘high-voltage battery’. Also, the terms ‘low-voltage battery’ and ‘high-voltage battery’ are used for convenience based on a relative difference between two batteries. However, the embodiment of the present disclosure is not limited thereto.

In order to determine which battery will be used in each section, the expected power for each section may be compared with maximum efficiency output power (e.g., set power) of the first battery MB.

Also, based on the comparison results, the usage plan may be determined so that the first battery MB is used in a section in which the expected power is equal to or less than the maximum efficiency output power, and the second battery SB is used in other sections.

Thereafter, in step S30, the first controller Ctrl 1 may determine a target temperature for the corresponding battery for each section for battery conditioning.

To this end, optimized temperature data for each battery state (e.g., SoH, SoC, voltage) may be stored (e.g., in advance) in memory.

Also, the data may be secured through an experiment.

Also, the optimized temperature data may be secured according to characteristics of each battery. For example, the optimized temperature data may be obtained based on characteristics (or specifications), such as a C-rate, a nominal voltage, an efficiency, maximum current, a system voltage, and continuous output (power) of a battery.

The first battery MB and the second battery SB may have different characteristics. Thus, a target temperature for the section in which the first battery MB is used may be determined based on the temperature data or closest data of the characteristics of the first battery MB. A target temperature for the section in which the second battery SB is used may be determined in the same manner.

Thereafter, in step S40, the first controller Ctrl 1 checks the usage plan for the dual batteries and may perform an adjustment thereof when necessary.

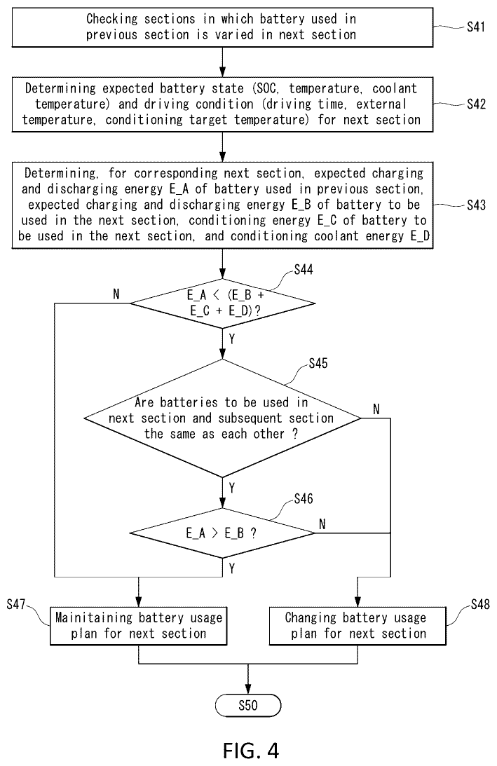

Hereinafter, an example of step S40 is described in detail with reference to FIG. 4.

First, in step S41, the first controller Ctrl 1 checks sections in which the battery used in the previous section is changed in the next section. That is, for example, the first battery is used as the charging battery in section 1, and the second battery is used as the charging battery in section 2 that is a next section.

When the first controller Ctrl 1 checks that batteries used in two consecutive sections are changed in step S41, the usage plan may be adjusted through steps S42 to S48.

To this end, in step S42, the first controller Ctrl 1 determines an expected battery state and a driving environment of the first battery MB and the second battery SB for the next section. Here, the expected battery state may include SOC, temperature, and coolant temperature, and the driving environment may include driving time, ambient temperature, and conditioning target temperature. The battery state and the driving environment may be determined based on sensor information and/or a mathematical model. For example, the SOC may be determined based on a battery usage plan for each section and expected charging and discharging power, and the battery temperature may be determined by a temperature expectation model based on the battery usage plan. Also, the coolant temperature may be determined based on the conditioning target temperature based on the usage plan.

Thereafter, in step S43, the first controller Ctrl 1 determines expected charging and discharging energy E_A of the battery used in the previous section, expected charging and discharging energy E_B of the battery to be used in the next section, conditioning energy E_C of the battery to be used in the next section, and conditioning coolant energy E_D of the next section.

Here, the above-described energy may be determined by the following mathematical equations in set 1.

### Mathematical Equations, Set 1

$$E\_A = Dt \times I\_pb , c , {d}^{2} \times R\_pb$$

$$E\_B = Dt \times I\_nb , c , {d}^{2} \times R\_nb$$

$$E\_C = M\_nb \times ρ\_nb \times \vert T\_nb , t - T\_nb , w \vert \times Dt$$

$$E\_D = M\_nb , cw \times ρ\_nb , cw \times \vert T\_nb , cw - T\_a \vert \times Dt$$

For the above mathematical equations in set 1, Dt represents a driving time for the corresponding section, I_pb,c,d represents a combined current value of absolute values of expected charging and discharging current of the battery used in the previous section, R_pb represents system resistance of the battery used in the previous section, I_nb,c,d represents a combined current value of absolute values of expected charging and discharging currents of the battery to be used in the next section, R_nb represents system resistance of the battery to be used in the next section, M_nb represents a mass of the battery to be used in the next section, ρ_nb represents specific heat of the battery to be used in the next section, T_nb,t represents a conditioning target temperature of the battery to be used in the next section, T_nb,cw represents a coolant temperature for conditioning the battery to be used in the next section, M_nb,cw represents a mass of the coolant for conditioning the battery to be used in the next section, ρ_nb,cw represents specific heat of the coolant for conditioning the battery to be used in the next section, and T_a represents an external temperature.

Thereafter, in step S44, the first controller Ctrl 1 compares the above-described energy of the battery used in the previous section with the above-described energy determined for the battery to be used in the next section.

That is, the first controller Ctrl 1 determines whether the expected charging and discharging energy E_A of the battery used in the previous section is less than a sum of the expected charging and discharging energy E_B, the conditioning energy E_C, and the conditioning coolant energy E_D of the battery to be used in the next section.

When the expected charging and discharging energy E_A of the battery used in the previous section is less than the combined energy (e.g., Y (yes) in step S44), the first controller Ctrl 1 determines whether the battery to be used in the next section is the same as the battery to be used in a subsequent section of the next section (hereinafter, referred to as a subsequent section) in step S45.

When the batteries to be used in the next and subsequent sections are the same as each other (e.g., Y in step S45), the first controller Ctrl 1 determines whether the expected charging and discharging energy E_A of the battery used in the previous section is greater than the expected charging and discharging energy E_B of the battery to be used in the next section in step S46.

When the expected charging and discharging energy E_A of the battery used in the previous section is greater than that of the battery to be used in the next section (e.g., Y in step S46), the first controller Ctrl 1 determines to maintain the current battery usage plan for the next section in step S47. That is, in this case, the initial usage plan for the next section remains unchanged.

Here, when the expected charging and discharging energy E_A of the battery used in the previous section is not greater than the expected charging and discharging energy E_B of the battery to be used in the next section (e.g., N (no) in step S46), the first controller Ctrl 1 changes the battery usage plan for the next section in step S48. In this case, the initial usage plan for the next section is changed, and the battery used in the previous section is determined to be (e.g., continuously) used in the next section.

On the other hand, when it is determined in step S44 that the expected charging and discharging energy E_A of the battery used in the previous section is not less than the combined energy E_B+E_C+E_D (e.g., N in step S44), the first controller Ctrl 1 performs the above-described step S47.

Also, when the batteries to be used in the next section and the subsequent section are not the same as each other in step S45 (e.g., N in step S45), the first controller Ctrl 1 performs step S48.

The confirmation and adjustment of the battery usage plan described above in step S40 may be performed before entering the next section and before executing the conditioning control for the battery to be used in the next section. However, this example embodiment of the present disclosure is not limited thereto. For example, the step S40 may be performed before the driving is initiated.

Referring to FIG. 3 again, in step S50, the first controller Ctrl 1 discharges or charges the first battery MB and the second battery SB based on the battery usage plan.

Also, the first controller Ctrl 1 performs conditioning control of the first battery MB and the second battery SB based on the usage plan and the target temperature for each section.

The conditioning control may include, for example, heating the corresponding battery to the target temperature using an electric heater.

Also, the conditioning control may be executed by using power of the rest battery in the section before the corresponding battery is used.

For example, the conditioning control for the second battery SB to be used in the next section may be performed by using the power of the first battery MB in a section in which the first battery MB is used.

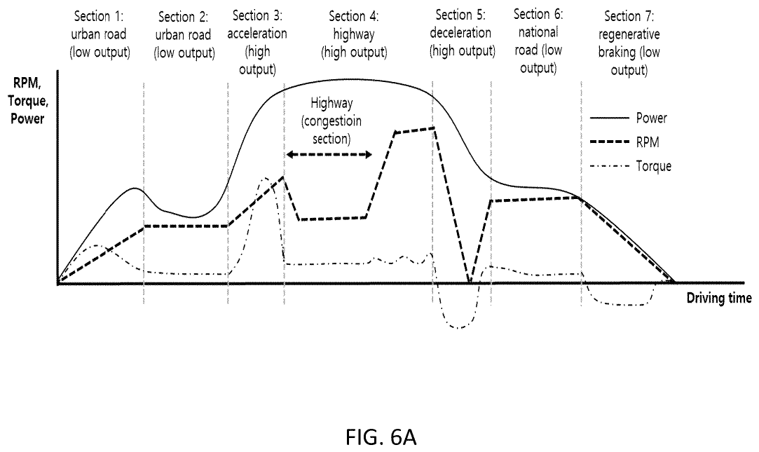

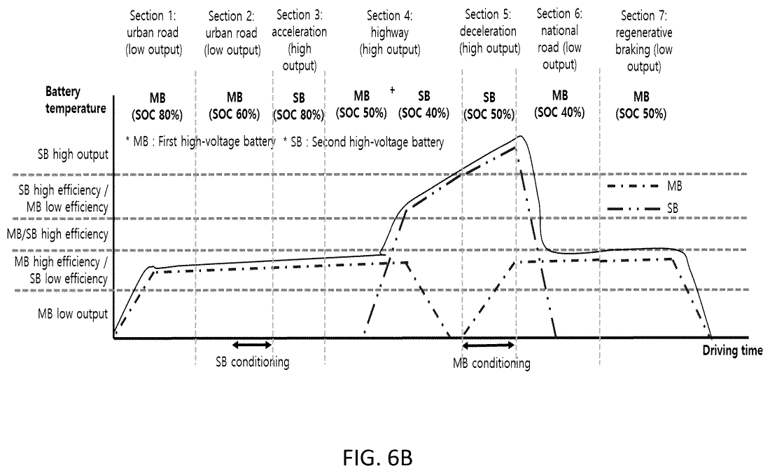

FIGS. 6A and 6B are graphs illustrating a driving simulation according to an example embodiment of the present disclosure, which will be described below.

First, FIG. 6A illustrates the number of rotation RPM and torque of the driving motor and the discharge or charging power, for each section when sections 1 to 6 are distinguished for the expected driving path.

Sections 1 to 6 may be distinguished based on reference that distinguish driving conditions based on map data as described above.

In FIGS. 6A and 6B, sections 1 and 2 represent urban road sections with low output power, section 3 represents a high-output acceleration section (e.g., an uphill mountainous road), section 4 represents a high-output highway section, section 5 represents a regenerative braking section characterized by high-output regenerative power during deceleration (e.g., a downhill mountainous road), section 6 represents a low-output national road section, and section 7 represents a regenerative braking section with low-output regenerative power.

As shown, it is determined that the battery used in sections 1, 2, 6, and 7 is the first battery MB that is the lower voltage battery among the two batteries, and the battery used in sections 3 and 5 is the second battery SB.

Although the usage plan is determined to use the first battery MB in section 4, the second battery SB is used together with the first battery MB because the first battery MB alone may not satisfy the requested power of the driver.

As the battery is used based on the usage plan, the SoC of the first battery MB decreases from 80% in section 1 to 60% in section 2, 50% in section 4, and 40% in section 6 and is recovered to 50% in section 7 by the regenerative braking power.

On the other hand, the SoC of the second battery SB is 80% in section 3, decreases to 40% in section 4, and then recovered to 50% in section 5 by charging.

Also, section 3, according to the plan to use the second battery SB, pre-conditioning of the second battery SB is performed by using the power of the first battery MB in the section 2.

Likewise, according to the plan to use the first battery MB in section 6, pre-conditioning of the first battery MB is performed by using the power of the second battery SB in section 5.

FIG. 6B illustrates the battery temperature during driving from section 1 to section 7. When the corresponding temperature is obtained through the conditioning control, since the battery usage plan is different for each driving condition according to the example embodiment, energy consumed for battery conditioning approximately corresponds to an area expressed by solid line.

In contrast, in case of a comparative example that does not have a battery usage plan instead of the example embodiment, the first battery MB and the second battery SB may perform the conditioning control in the same or similar manner. Thus, energy consumed for the conditioning control may approximately correspond to two times of the area expressed by the solid line.

Thus, according to the example embodiment, the battery conditioning may be (e.g., efficiently) performed, and thus, the consumed energy may be reduced.

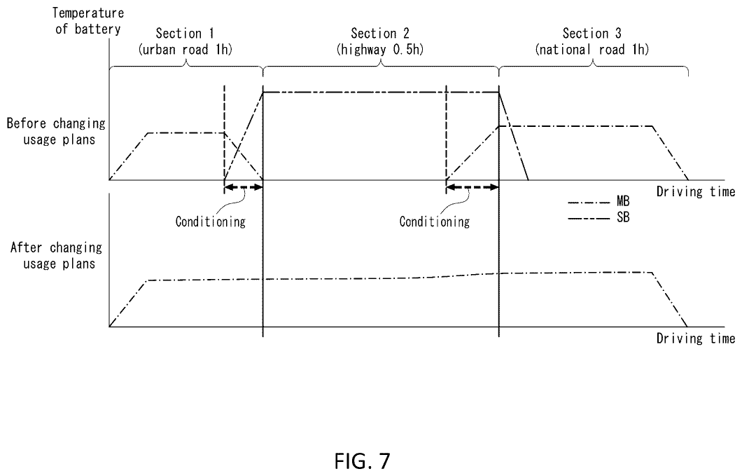

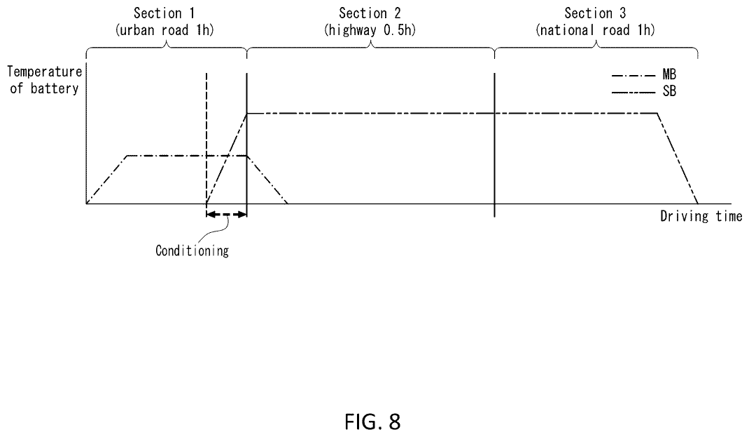

FIGS. 7 and 8 are views illustrating another assumed driving simulation according to an example embodiment of the present disclosure, which will be described hereinbelow.

In FIG. 7, section 1 represents an urban road driving section with a driving time of 1 hour, section 2 represents a highway driving section with a driving time of 30 minutes, and section 3 represents a national road driving section with a driving time of 1 hour for a total expected driving distance.

As shown in FIG. 7, in an initial usage plan, such as a used plan before correction, it is assumed that the first battery MB is used in the section 1, the second battery SB is used in the section 2, and the first battery MB is used again in the section 3.

Here, since the battery to be used is changed in consecutive sections of sections 1 and 2, the usage plan may be changed based on energy efficiency after checking the usage plan before entering the section 2.

That is, the first controller Ctrl 1 determines the expected energy ‘EA’ required when driving in section 2 using the first battery MB, determines the combined energy ‘E_B+E_C+E_D’ when driving in the section 2 using the second battery SB as planned, and then compares the two energies.

In this assumption, since the ‘E_A’ is less than ‘E_B+E_C+E_D’, the first controller Ctrl 1 additionally determines whether the battery to be used in section 3 is the same as the battery to be used in section 2.

In this example, since ‘E_A’ is less than ‘E_B+E_C+E_D’ and the batteries to be used in sections 2 and 3 are different from each other, the first controller Ctrl 1 changes the usage plan to (e.g., continuously) use the first battery MB instead of the second battery SB to be used in section 2.

On the other hand, in an example of FIG. 8, it is assumed that the usage plan is determined such that the first battery MB is used in section 1 and the second battery SB is used in sections 2 and 3 for the same driving section.

Also, like the case of FIG. 7, it is assumed that the battery to be used is changed in the consecutive sections of sections 1 and 2, and ‘E_A’ is less than ‘E_B+E_C+E_D’.

However, in the example of FIG. 8, since the battery to be used in section 3 that corresponds to the subsequent section is the same as the battery to be used in section 2, whether the usage plan is corrected is determined by further performing the above-described step S46.

In this assumption, it is assumed that ‘E_A’ is greater than ‘E_B’. Thus, according to the step S47, the battery to be used in section 2 remains unchanged from the initial usage plan.

According to an example embodiment of the present disclosure, the driving distance of the electric vehicle may be extended, and the usability thereof may be improved by detachably connecting the second high-voltage battery to the power system of the electric vehicle.

Also, according to an example embodiment of the present disclosure, the efficiency and lifespan of the battery may be increased by (e.g., efficiently) operating the dual batteries based on the learned driving condition and the driving habits of the driver for each driving condition.

Also, the energy efficiency may be optimized through the individual operation of the dual batteries based on the driving habits of the driver for each driving condition.

Also, according to an example embodiment of the present disclosure, when the energy efficiency is reduced by replacing and using the dual batteries in sections with short driving times, the energy efficiency may be further improved by correcting the usage plan.

Also, the energy consumed for conditioning the dual batteries may be reduced through the individual conditioning control based on the usage plan.

Also, the high-efficiency area of the battery may be used immediately when the battery is replaced through the pre-conditioning,

Although embodiments of the present disclosure have been described above, these are illustrative examples and should not be construed as limiting the present disclosure to these embodiments.

What is claimed is:

1. A method for controlling usage of dual batteries including a first battery and a second battery to supply power to a driving motor for wheel driving installed in a vehicle, the method comprising:
determining a usage plan of at least one of the first battery or the second battery for a plurality of sections of an expected driving path;
changing usage plans for two consecutive sections of the plurality of sections when a battery for a previous section of the two consecutive sections is different from a battery for a next section of the two consecutive sections; and
charging or discharging the first battery or the second battery based on the changed usage plans.

2. The method of claim 1, wherein changing the usage plans comprises changing the usage plans based on an energy efficiency condition for the next section of the two consecutive sections.

3. The method of claim 2, wherein the energy efficiency condition is based on a first consumed energy estimated by using the battery for the previous section in the next section and a second consumed energy estimated by using the battery for the next section in the next section.

4. The method of claim 3, wherein the first consumed energy comprises consumed energy of the battery for the previous section to drive the vehicle in the next section.

5. The method of claim 4, wherein the second consumed energy comprises consumed energy of the battery for the next section to drive the vehicle in the next section, conditioning energy of the battery for the next section to prepare to drive the vehicle in the next section, and coolant energy for the conditioning energy.

6. The method of claim 1, wherein changing the usage plans comprises comparing consumed energy of the battery for a previous section of the two consecutive sections to drive the vehicle in a next section of the two consecutive sections with combined energy of consumed energy of the battery for the next section to drive the vehicle in the next section, conditioning energy of the battery for the next section to prepare to drive the vehicle in the next section, and coolant energy for the conditioning energy.

7. The method of claim 6, wherein changing the usage plans further comprises determining whether the battery for the next section is the same as a battery for a subsequent section of the next section when the consumed energy of the battery for the previous section to drive the vehicle in the next section is less than the combined energy.

8. The method of claim 7, wherein changing the usage plans further comprises comparing the consumed energy of the battery for the previous section to drive the vehicle in the next section with the consumed energy of the battery for the next section to drive the vehicle in the next section when the battery for the next section is the same as the battery for the subsequent section of the next section.

9. The method of claim 8, wherein changing the usage plans comprises:
maintaining the usage plan of the next section when the consumed energy of the battery for the previous section to drive the vehicle in the next section is greater than the consumed energy of the battery for the next section to drive the vehicle in the next section; and
changing the usage plan of the next section when the consumed energy of the battery for the previous section to drive the vehicle in the next section is smaller than or equal to the consumed energy of the battery for the next section to drive the vehicle in the next section.

10. The method of claim 7, wherein changing the usage plans further comprises:
maintaining the usage plan of the next section when the consumed energy of the battery for the previous section to drive the vehicle in the next section is greater than or equal to the combined energy; and
changing the usage plan of the next section when the battery for the next section is different from the battery for the subsequent section of the next section.

11. A vehicle comprising:
a plurality of wheels;
a driving motor configured to drive at least one of the plurality of wheels; and
a controller configured to control a power flow between the driving motor and a first battery or a second battery, the controller comprising a memory storing computer-readable instructions and at least one processor configured to access the memory and execute the computer-readable instructions,
wherein the computer-readable instructions comprise:
determining a usage plan of the first battery or the second battery for each section of a plurality of sections of an expected driving path;
changing usage plans for two consecutive sections when a battery for a previous section of two consecutive sections of the plurality of sections is different from a battery for a next section of the two consecutive sections; and
charging or discharging the first battery or the second battery based on the changed usage plans.

12. The vehicle of claim 11, wherein changing the usage plans comprises changing the usage plans based on an energy efficiency condition for the next section of the two consecutive sections.

13. The vehicle of claim 12, wherein the energy efficiency condition is based on a first consumed energy estimated by using the battery for the previous section in the next section and a second consumed energy estimated by using the battery for the next section in the next section.

14. The vehicle of claim 13, wherein the first consumed energy comprises consumed energy of the battery for the previous section to drive the vehicle in the next section.

15. The vehicle of claim 13, wherein the second consumed energy comprises consumed energy of the battery for the next section to drive the vehicle in the next section, conditioning energy of the battery for the next section to prepare to drive the vehicle in the next section, and coolant energy for the conditioning energy.

16. The vehicle of claim 11, wherein changing the usage plans comprises comparing consumed energy of the battery for a previous section of the two consecutive sections to drive the vehicle in a next section of the two consecutive sections with combined energy of consumed energy of the battery for the next section to drive the vehicle in the next section, conditioning energy of the battery for the next section to prepare to drive the vehicle in the next section, and coolant energy for the conditioning energy.

17. The vehicle of claim 16, wherein changing the usage plans further comprises determining whether the battery for the next section is the same as a battery for a subsequent section of the next section when the consumed energy of the battery for the previous section to drive the vehicle in the next section is less than the combined energy.

18. The vehicle of claim 17, wherein changing the usage plans further comprises comparing the consumed energy of the battery for the previous section to drive the vehicle in the next section with the consumed energy of the battery for the next section to drive the vehicle in the next section when the battery for the next section is the same as the battery for the subsequent section of the next section.

19. The vehicle of claim 18, wherein changing the usage plans comprises:
maintaining the usage plan of the next section when the consumed energy of the battery for the previous section to drive the vehicle in the next section is greater than the consumed energy of the battery for the next section to drive the vehicle in the next section; and
changing the usage plan of the next section when the consumed energy of the battery for the previous section to drive the vehicle in the next section is smaller than or equal to the consumed energy of the battery for the next section to drive the vehicle in the next section.

20. The vehicle of claim 17, wherein changing the usage plans further comprises:
maintaining the usage plan of the next section when the consumed energy of the battery for the previous section to drive the vehicle in the next section is greater than or equal to the combined energy; and
changing the usage plan of the next section when the battery for the next section is different from the battery for the subsequent section of the next section.
